(19) United States
(12) Patent Application Publication
(10) Pub. No.: US 2013/0179064 A1
(43) Pub. Date: Jul. 11, 2013

(54) HAND-HELD DEVICE WITH DIRECTIONAL NOTIFICATION

(71) Applicants: Robert T. Arenburg, Round Rock, TX (US); Franck Barillaud, Austin, TX (US); Shivnath Dutta, Round Rock, TX (US); Alfredo V. Mendoza, Georgetown, TX (US)

(72) Inventors: Robert T. Arenburg, Round Rock, TX (US); Franck Barillaud, Austin, TX (US); Shivnath Dutta, Round Rock, TX (US); Alfredo V. Mendoza, Georgetown, TX (US)

(73) Assignee: INTERNATIONAL BUSINESS MACHINES CORPORATION, Armonk, NY (US)

(21) Appl. No.: 13/345,365

(22) Filed: Jan. 6, 2012

(51) Int. Cl. G01C 21/00

(52) U.S. Cl. 701/400

(57) ABSTRACT

A portable electronic device receives wireless signals from an external signal-generating source. The wireless signals include offering identifiers that are associated with an offering at a location of the external signal-generating source. The portable electronic device may determine the offering identifier from the wireless signal, and match the offering identifier with one or more offerings of interest that are selected by the user. The portable electronic device may determine the direction from which the wireless signal is received based on the strength of the wireless signal received by the antenna, and presenting an indicator to the user that indicates the direction to the location of the external signal-generating source if the offering identifier matches one or more of the offerings of interest as selected by the user.

### FIELD

The subject matter disclosed herein relates to approaches to providing directions, and more particularly relates to providing directions based at least in part on signals received by a hand-held device.

### BACKGROUND

### Description of the Related Art

Electronic devices are being used more and more often to provide directions to their owners. Smart phones, tablets, Global Positioning System (GPS) units, and other electronic devices are often capable of helping a user determine how to get from one point to another. While such devices can be useful in providing coarse direction information, they often perform poorly at providing more granular direction.

For example, a user may be at a trade show, or in a shopping mall. These sorts of environments (and others) often have multiple points of interest within a single location. Traditional approaches to providing a user with direction are not particularly useful for a user who is looking for a particular vendor at a trade show, or for a particular product in a shopping mall. The user generally has to wander the area and try to find a vendor or items of interest.

### BRIEF SUMMARY

A method for providing directions to an external signal-generating source is disclosed. An apparatus and computer program product also perform the functions of the method. In one embodiment, the method involves receiving a wireless signal from an external signal-generating source. The wireless signal may include an offering identifier that is associated with an offering at a location of the external signal-generating source. The method may also involve determining the offering identifier from the wireless signal, and matching the offering identifier with one or more offerings of interest selected by a user.

The method may also involve determining a direction from which the wireless signal is received based on the strength of the wireless signal received by an antenna. The method may further involve presenting an indicator to the user that indicates the direction to the location of the external signal-generating source. The indicator may be presented in response to the offering identifier matching with one or more of the offerings of interest selected by the user.

One embodiment of the invention may also be realized as a system. In one embodiment, the system includes a portable electronic device that comprises a processor and memory. The system may also include an antenna module that receives a wireless signal from an external signal-generating source. The system may also include an offering module that determines the offering identifier from the wireless signal and a filter module that matches the offering identifier with one or more offerings of interest selected by a user. The system may further include a direction module that determines the direction from which the wireless signal is received based on the strength of the wireless signal received by the antenna module. A notification module may present an indicator to the user that indicates the direction to the location of the external signal-generating source in response to the offering identifier matching with one or more of the offerings of interest selected by the user.

The invention may also be realized as an apparatus that comprises an antenna module, an offering module, a filter module, a direction module, and a notification module. The antenna module receives a wireless signal from an external signal-generating source. The wireless signal includes an offering identifier associated with an offering at the location of the external signal-generating source. The offering module determines the offering identifier from the wireless signal. The filter module matches the offering identifier with one or more offerings of interest selected by a user. The direction module determines a direction from which the wireless signal is received based on a strength of the wireless signal received by the antenna module. The notification module presents an indicator to the user that indicates the direction to the location of the external signal-generating source in response to the offering identifier matching with one or more of the offerings of interest selected by the user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system comprising an external signal generating source and a portable electronic device;

FIG. 2 is a schematic block diagram illustrating another embodiment of a system comprising an external signal generating source and a portable electronic device, where the portable electronic device comprises a directional apparatus;

FIG. 3 is a schematic block diagram illustrating another embodiment of a system comprising an external signal generating source and a portable electronic device with a multi-directional antenna;

FIG. 4 is a schematic block diagram illustrating another embodiment of a system comprising an external signal generating source and a portable electronic device displaying an indicator;

FIG. 5 is a schematic block diagram illustrating another embodiment of a system comprising a plurality of external signal generating sources and a portable electronic device displaying multiple indicators; and

FIG. 6 is a schematic flow chart diagram illustrating one embodiment of a method for providing directions to the location of an external signal-generating source with an offering of interest at its location.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

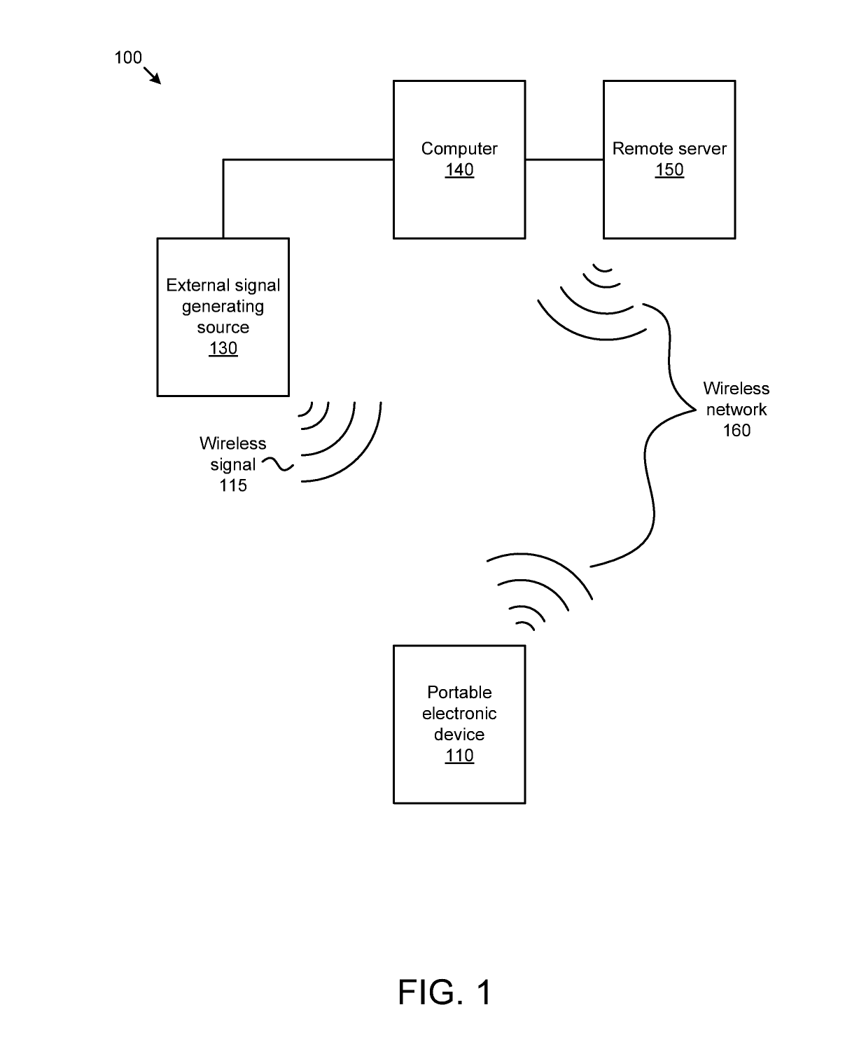

FIG. 1 is a schematic drawing illustrating one embodiment of a system 100 comprising an external signal-generating source 130 generating a wireless signal 115, and a portable electronic device 110. As used in this application, an external signal-generating source 130 is a machine that generates and broadcasts a digital wireless signal 115 that contains digital information, and that is external to the portable electronic device 110. In certain embodiments, the external signal-generating source 130 includes a medium range wireless transmitter.

Examples of medium range wireless technologies include Wi-Fi, Bluetooth, radio frequencies, cellular technologies, microwave transmission, or any other wireless communication method. Thus, in one embodiment, the external signal-generating source 130 uses Wi-Fi to broadcast the wireless signal 115 to devices (such as the portable electronic device 110) that are in range of the external signal-generating source 130. In certain embodiments, the external signal-generating source 130 may generate a wireless signal 115 that is unencrypted such that any suitable device, within range, can receive and use the wireless signal 115. In certain embodiments, the external signal-generating source 130 is only configured to send digital information using the wireless signal 115, but is not configured to receive digital information from devices within range.

The wireless signal 115, as that term is used in this specification, is a signal sent using an appropriate wireless technology (such as Wi-Fi, Bluetooth, etc.) and that comprises an offering identifier. The offering identifier is digital data that is associated with an offering at the location of the external signal-generating source 130. In one embodiment, the offering identifier is the name of the product available at the location of the external signal-generating source 130. For example, if the external signal-generating source 130 is set up at a booth that has flat screen televisions, the offering identifier may be “flat screen televisions.” Other examples of offering identifiers are discussed below.

The portable electronic device 110, as that term is used in this application, refers to a physical device capable of receiving and interpreting a wireless signal 115 containing digital information, and which is portable. The portable electronic device 110 includes a processor for executing instructions, and memory for storing instructions. The portable electronic device 110 may be, for example, a cellular phone, a tablet computer, a Global Positioning System (GPS) receiver, a laptop, a personal digital assistant (PDA), an eReader, or other variety of portable electronic device.

The portable electronic device 110 receives the wireless signal 115 from the external signal generating source 130 and determines the offering identifier from the wireless signal 115. The portable electronic device 110 then matches the offering identifier with one or more offerings of interest selected by a user. For example, at an electronics trade show, the user may select offerings of interest such as flat screen televisions and computers.

The portable electronic device 110 may also determine the direction from which the wireless signal 115 is received based on the strength of the wireless signal 115 received by an antenna in the portable electronic device 110. The portable electronic device 110 may then present an indicator to the user that indicate the direction to the location of the external signal generating source 130 if the offering identifier in the wireless signal 115 matches one or more of the offerings of interest selected by the user. For example, assuming that the user selected flat screen televisions as an offering of interest, and that the wireless signal 115 includes an offering identifier that specifies that flat screen televisions are offered at the location of the external signal generating source 130, the portable electronic device 110 may present indicators (such as arrows) that guide the user to the location of the external signal generating source 130.

The external signal-generating source 130 is a device that can transmit a wireless signal 115 that can be received and read by electronic devices, such as the portable electronic device 110. The external signal-generating source 130 includes an antenna for broadcasting the wireless signal 115. The external signal-generating source 130 may be configured with input devices (such as a keyboard and mouse) and output devices (such as a screen) that allow a user to directly input information into the external signal-generating source 130. For example, the user may be able to enter offering identifiers (such as a store name, or a description of the goods or services available). In other embodiments, the external signal-generating source 130 may connect to a device such as a computer 140 that can configure the external signal-generating source 130. For example, the external signal-generating source 130 may connect to a computer 140 via a universal serial bus (USB) connection. The user may provide information and configure the external signal-generating source 130 using the computer 140 to which the external signal-generating source 130 is attached.

In other embodiments, the external signal-generating source 130 may connect to a computer 140 using a wireless connection such as Wi-Fi or Bluetooth. The external signal-generating source 130 may receive information from a remote server 150 that is connected to the computer 140. For example, the external signal-generating source 130 may be able to access and retrieve data from the Internet using its connection to the computer 140. The external signal-generating source 130 may be able to communicate with other external signal-generating sources 130 within range, and may repeat a wireless signal 115 received from those external signal-generating sources 130. In this manner, a group of external signal-generating sources 130 may cooperate to extend the range of the wireless signal 115 beyond the physical limits of the actual wireless signal 115. Other configurations of an external signal-generating source 130, different from the examples given above, may also be implemented.

The portable electronic device 110 may be configured to work seamlessly with other guidance technologies such as Global Positioning System (GPS) technology. A GPS system typically has a capability to provide directions, including arrows, pointers, etc. to lead a user along roads, freeways, etc., but typical GPS systems may only lead a user to an address and not to various locations at the address. For example, GPS technology may be useful to get a user to a facility housing the electronics trade show in the above example, but may not be useful for guiding the user to individual booths. In another embodiment, GPS may be used to guide a user to a mall, but may not be useful to guide the individual to particular stores within the mall. In another situation, GPS can be used to guide a user to a downtown area of a city, but may offer limited assistance in finding individual stores, kiosks, attractions, etc. In one embodiment, the system 100 may be used at events with temporary booths, attractions, etc. where a GPS system may not include the temporary booths, attractions, etc. Store owners, people at a booth, etc. may be able to quickly set up an external signal-generating source 130 and other components of the system 100 to guide a user in finer detail than a GPS system.

In certain embodiments, the portable electronic device 110 is configured to use GPS to provide the user with directions to a particular location, but then switches to the guidance system using wireless signals 115 described herein once the user reaches the particular location. In another embodiment, a navigation program that uses GPS is constantly monitoring for wireless signals 115 having offering identifiers, and notifies the user if an appropriate wireless signal 115 (and associated offering) is detected.

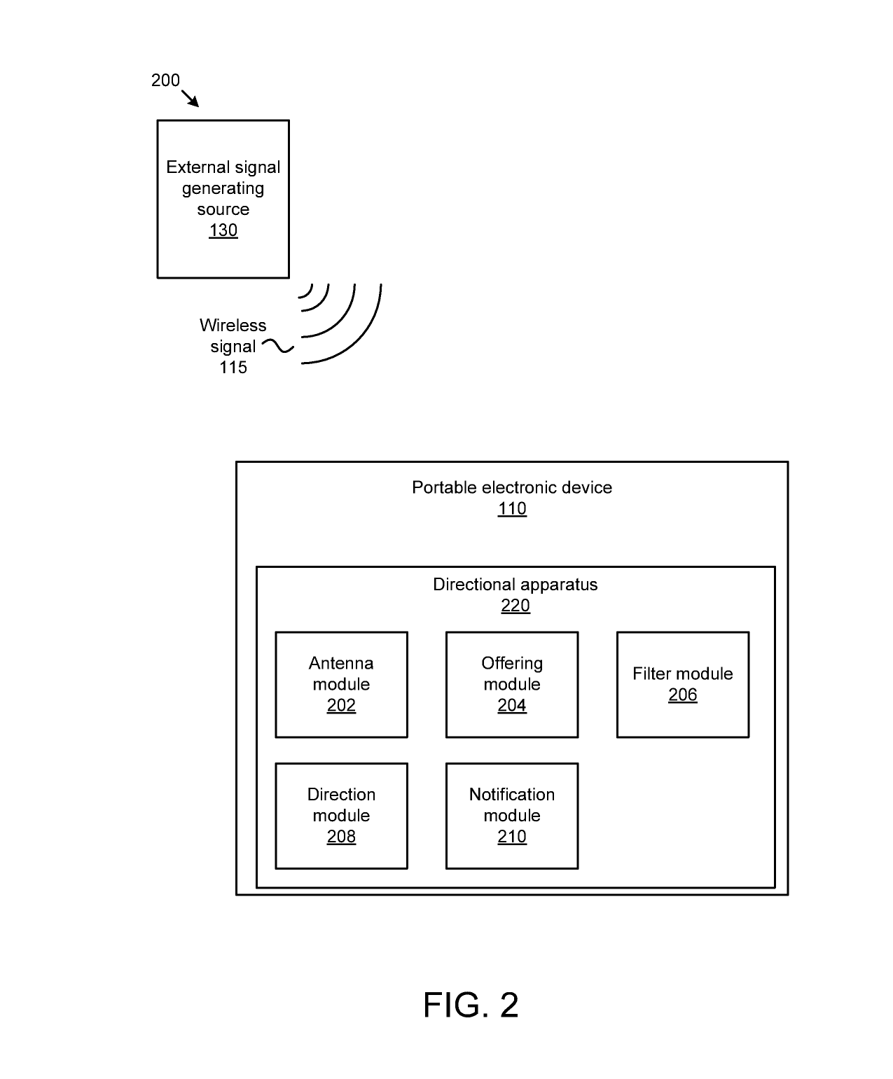

FIG. 2 shows a system 200 comprising an external signal-generating source 130 broadcasting a wireless signal 115 to a portable electronic device 110. The portable electronic device 110 may include a directional apparatus 220 for determining a location of the external signal-generating source 130 using the wireless signal 115, and notifying the user of the portable electronic device 110 if the offerings available at the location of the external signal-generating source 130 match offerings of interest selected by the user.

In one embodiment, the directional apparatus 220 includes an antenna module 202. The antenna module 202 receives the wireless signal 115 from the external signal-generating source 130. As discussed above, the wireless signal 115 may include an offering identifier that is associated with an offering at the location of the external signal-generating source 130. The offering module 204 may determine the offering identifier from the wireless signal 115. The directional apparatus 220 may also include a filter module 206 that matches the offering identifier from the wireless signal 115 with one or more offerings of interest selected by the user. The directional module 208 may determine a direction from which the wireless signal 115 is received based on the strength of the wireless signal 115 received by the antenna module 202. The notification module 210 may present an indicator to the user that indicates the direction to the location of the external signal-generating source 130 in response to the offering identifier matching with one or more offerings of interest selected by the user. Further details of the modules are provided below.

As noted above, the wireless signal 115 includes an offering identifier that is associated with an offering at the location of the external signal-generating source 130. The offering identifier may be, for example, the name of a store. The offering identifier may be product information or service information; for example, the offering identifier may be the words “flat screen television” or “portable computers.”

In certain embodiments, the offering identifier may be a digital identification such as an alphanumeric identifier. The digital identification may be used to retrieve a store name, product information, service information, or other information from a source that is separate from the external signal-generating source 130. For example, the wireless signal 115 may transmit an offering identifier that is an alphanumeric identifier. The portable electronic device 110 may receive the offering identifier and send the alphanumeric identifier to a remote server 150 via an Internet connection. The remote server 150 may be configured to receive the alphanumeric identifier, determine information about the offering that is associated with the alphanumeric identifier (for example, the store name, products, etc), and to send that information to the portable electronic device 110. Such an embodiment may allow persons setting up and maintaining the external signal-generating source 130 to easily change and update the nature of the exact information that is sent to the users of the portable electronic devices.

The remote server 150 may communicate with the portable electronic device 110 over a wireless network 160. This wireless network 160 may be a cellular network a radio frequency network, or other network that allows communication using the portable electronic device 110. For example, where the portable electronic device 110 is a cellular phone, the remote server 150 may be part of the equipment of a cellular network provider. Other equipment may be included in the wireless network 160 connecting the portable electronic device 110 with the remote server 150, such as repeaters on towers, satellites, radio towers, routers, etc. One of skill in the art will recognize other equipment and components that form a wireless network capable of providing a wireless signal 160 between a portable electronic device 110 and a remote server 150.

The computer 140 may connect to the external signal-generating source 130 via a variety of communications and network technologies. For example, the external signal-generating source 130 may connect to the computer 140 using wireless technologies (such as cellular, radio, Wi-Fi, and others). The external signal-generating source 130 may connect to the computer 140 using physical connections such as USB and Ethernet connections. The remote server 150 may connect to the computer 140 through a local area network (LAN), a wide area network (WAN), or other appropriate network (not shown). The remote server 150 may, for example, be available on the Internet, and the computer 140 may connect to the remote server 150 using Internet technologies and approaches. While FIG. 1 shows a computer 140, the computer 140 may not be necessary; for example, in certain embodiments, the external signal-generating source 130 may connect to the remote server 150 without the aid of a computer 140.

Various approaches may be used to allow a person maintaining the external signal-generating source 130 to provide the offering identifier in the wireless signal 115 to the portable electronic device 110. For example, if a store owner is maintaining the external signal-generating source 130, the store owner may generate an offering identifier and send it to the remote server 150 and to the signal-generating source 130. The user of the portable electronic device 110 may connect to the remote server 150 by way of the wireless network 160 using the portable electronic device 110 in order to view the various offerings that are available. The user may select the offering identifier entered by the store owner, allowing the directional apparatus 220 and associated modules 202-210 to provide the user with directions.

In another embodiment, the external signal-generating source 130 broadcasts an offering identifier known to the remote server 150 or computer 140 and the remote server 150 or computer 140 includes a link between the offering identifier and products offered by the store owner. The remote server 150 may then transmit to the portable electronic device 110 the products available from the store. For example, the user may conduct an internet search for a product and the remote server 150 may transmit available products to the portable electronic device 110. The user may then select a product and the remote server 150 may transmit the offering identifier to the portable electronic device 110.

The antenna module 202 may then receive the wireless signal 115 from the external signal-generating source 130 with the offering identifier and the offering module 204 may determine the offering identifier from the wireless signal 115. The filter module 206 then matches the offering identifier from the wireless signal 115 with the offering identifier linked to the selected offerings of interest (i.e. products) selected by the user and the directional module 208 determines a direction from which the wireless signal 115 is received based on the strength of the wireless signal 115 received by the antenna module 202.

In another embodiment, the external signal-generating source 130 broadcasts an offering identifier that is a code that links to products on the remote server 150. The user may select the product by communicating with the remote server 150 and receiving a code from the remote server 150. The portable electronic device 110 may use the code received from the remote server 150 to match the code that is transmitted by the external signal-generating source 130. Other variations, separate from the examples given above, may also be used.

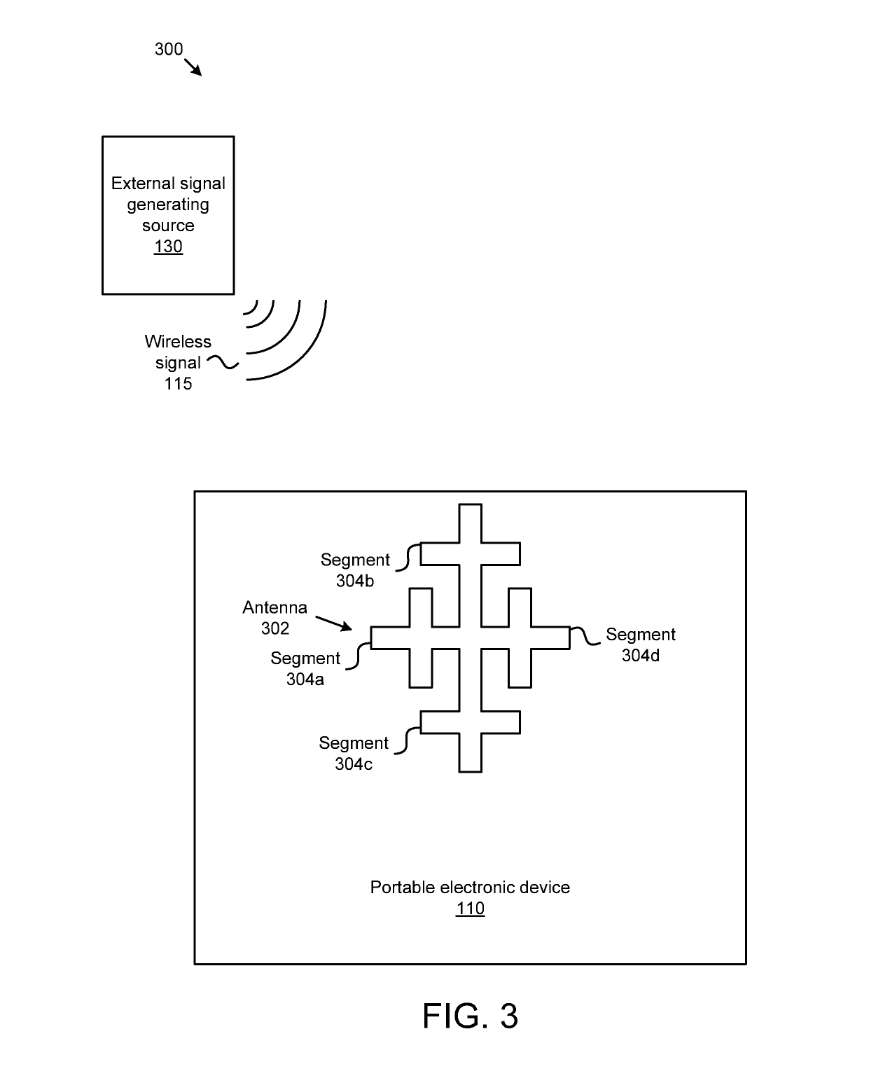

FIG. 3 shows one embodiment of a portable electronic device 110 comprising an antenna 302. The antenna 302 may be part of the antenna module 202. The antenna 302 receives the wireless signal 115 in the form of electromagnetic radiation. Other components of the antenna module 202 may be responsible for interpreting the wireless signal 115; for example, the antenna module 202 convert the analog wireless signal 115 into a digital signal which can be interpreted by the directional apparatus 220. The antenna 302 may be a Wi-Fi antenna, a Bluetooth antenna, or other suitable variety of antenna 302 that can receive a wireless signal 115.

The antenna 302 may be a multi-directional antenna comprising two or more segments 304. In one embodiment, the antenna 302 is a dipole antenna 302 comprising two segments 304. In other embodiments, such as that shown in FIG. 3, the antenna 302 has four segments. The antenna 302 may have more than the four segments 304 shown in FIG. 3. In certain embodiments, the segments 304 of the antenna 302 extend into the x, y, and z planes. In other embodiments, the segments 304 only extend into the x and y planes.

The antenna module 202 may be configured to determine the strength of the wireless signal 115 at one or more of the segments 304 of the antenna 302. Determining the direction from which the wireless signal 115 is received (and thus the location of the external signal-generating source 130) may be based on the strength of the wireless signal 115 at each of the segments 304 of the antenna 302.

For example, in FIG. 3, the antenna module 202 may determine that the strength of the wireless signal 115 received at the segment 304b is greater than the strength of the wireless signal 115 received at the segment 304c. The antenna module 202 may also determine that the strength of the wireless signal 115 received at the segment 304a is greater than the strength of the wireless signal 115 received at the segment 304d. Based on these measurements, the direction module 208 may determine that the direction from which the wireless signal 115 was received is, from the perspective of the page, up and to the left. In one embodiment, the notification module 210 displays an arrow on the screen of the portable electronic device 110 pointing up and to the left. In another embodiment, the direction module 208 may simply choose the segment 304 that received the strongest signal (for example, segment 304b) and display a directional arrow (or provide another indicator) in that direction.

The antenna module 202 may continually monitor the strengths of the wireless signal 115 at the segments 304 of the antenna 302. The direction module 208 and the notification module 210 may dynamically update the direction information presented to the user based on the changes in the strengths of the wireless signal 115 at the segments 304 of the antenna 302. Thus, as the user travels up in the example shown in FIG. 3, the strength of the wireless signal 115 at the segment 304a will increase relative to the strength of the wireless signal 115 at the segment 304b, until the user is eventually redirected to the left. This process continues until the user reaches the location of the external signal-generating source 130.

In other embodiments, the user takes action to help determine the direction from which the wireless signal 115 is received. For example, the antenna 302 may be a dipole antenna 302 with two segments 304. The user may be prompted to rotate the portable electronic device 110 360 degrees, during which time the antenna module 202 may sample the strength of the wireless signal 115 relative to the position of the portable electronic device 110. From this data, the direction module 208 may be able to determine the direction from which the wireless signal 115 is received, even if the antenna 302 has only two segments 304. Other variations of shapes of antennas 302 may also be possible.

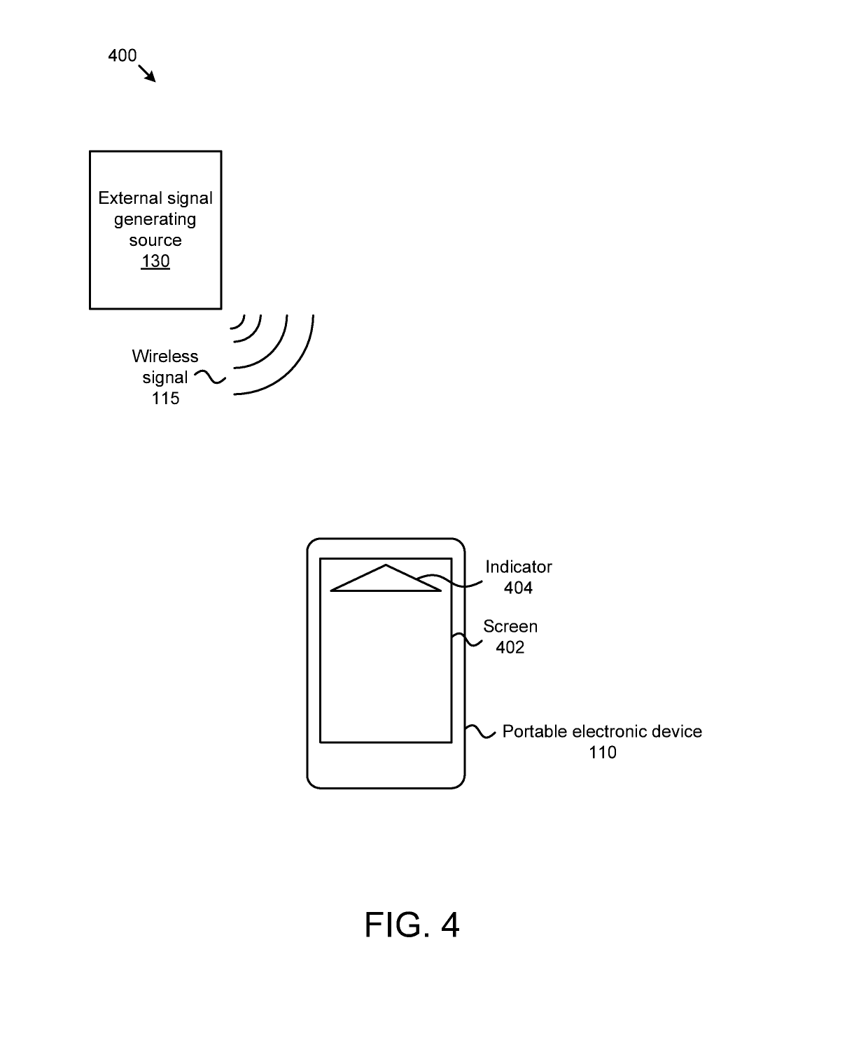

FIG. 4 shows a system 400 that includes an external signal generating source 130 and a portable electronic device 110. FIG. 4 depicts an indicator that is a graphical arrow 404 displayed on a screen 402 of the portable electronic device 110 by the notification module 210. The indicator 404 may, however, take any form that can effectively communicate a direction to a user of the portable electronic device 110. In one embodiment, the indicator 404 is a graphical indicator. The term “graphical indicator” is used broadly to encompass a variety of direction-indicating shapes or visual cues. For example, in one embodiment, the graphical indicator 404 is a square, circle, words, or other shapes which appears near an edge of the screen 402, thereby indicating the direction to the location of the external signal-generating source 130.

In other embodiments, the notification module 210 presents an indicator 404 that is audio as opposed to graphic. For example, the indicator 404 may be audio prompts such as “straight ahead,” “go left,” or others. Other suitable indicators 404 that can be used to indicate the direction to the location of the external signal-generating source 130 may also be used. In certain embodiments, the indicator 404 may be a combination of visual and audio cues that indicate a direction to a user of the portable electronic device 110.

As noted above, the direction module 208 may continually monitor the strength of the wireless signal 115 to provide updated directions to the user. As the user (and the portable electronic device 110) change location, the indicators 404 may be dynamically adjusted to compensate for the changes in location.

In certain embodiments, the portable electronic device 110 may have multiple display modes. For example, many portable electronic devices 110 can be held in a “portrait” orientation (as seen in FIG. 4), or in a “landscape” orientation. In certain embodiments, the notification module 210 may dynamically adjust the position of graphical indicators 404 to compensate for changes in orientation of the portable electronic device 110. Even for those portable electronic devices 110 that do not support multiple orientations, the notification module 210 may dynamically adjust the position of the graphical indicators 404 if the orientation of the portable electronic device 110 changes. For example, in FIG. 4, if the user turns the portable electronic device 110 clockwise 45 degrees, the notification module 210 may dynamically adjust the position of the indicator 404 such that it continues to point up, despite the change in orientation.

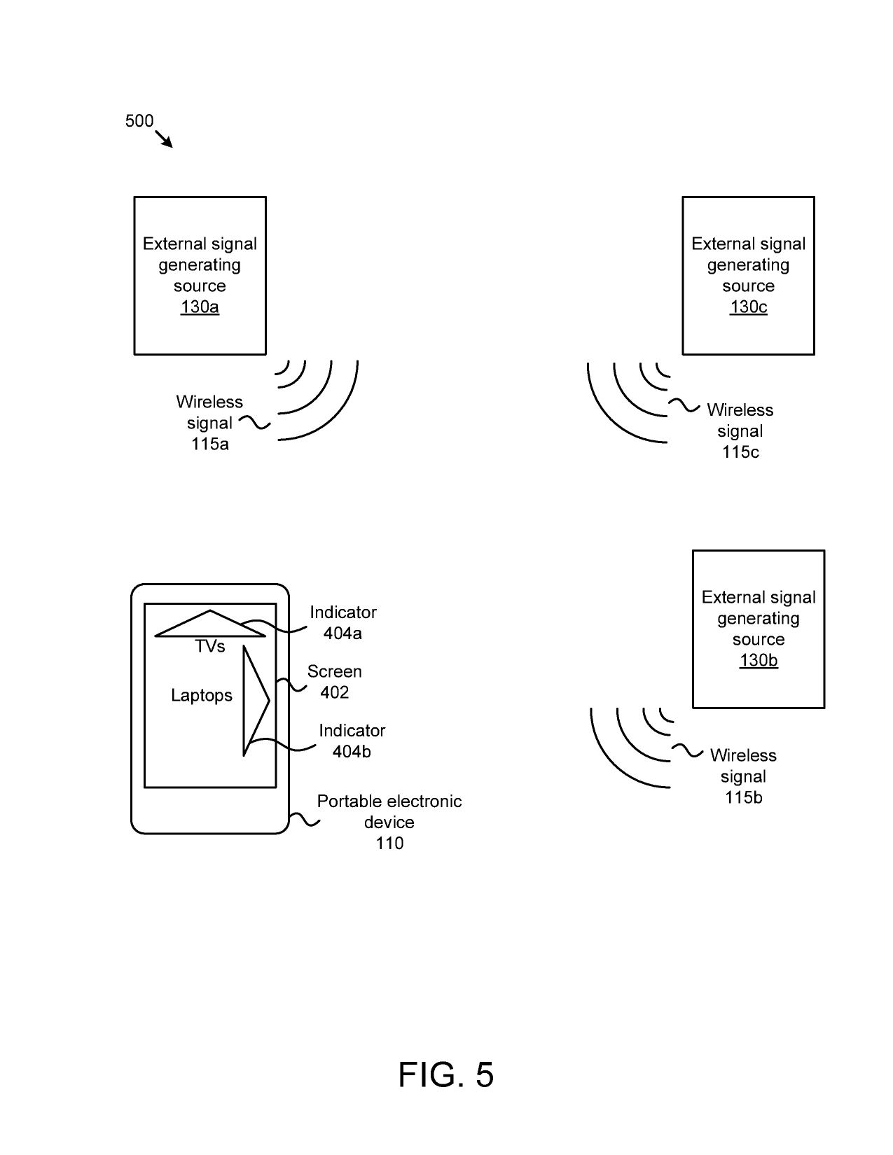

FIG. 5 shows one embodiment of a system 500 comprising a plurality of external signal-generating sources 130a-c and a portable electronic device 110. In the depicted embodiment, an external signal-generating source 130a is located in front of the portable electronic device 110, an external signal-generating sources 130b is located to the right of the portable electronic device 110, and an external signal-generating sources 130c is located in front of, and to the left of, the portable electronic device 110. The external signal-generating sources 130a-c generate the wireless signals 115a-c respectively.

As described above, the wireless signals 115a-c each contain an offering identifier that is associated with an offering at the respective locations of the respective external signal-generating sources 130a-c. In the example shown in FIG. 5, flat screen televisions may be available at the location of the external signal-generating sources 130a, laptop computers at the location of the external signal-generating sources 130b, and headphones at the location of the external signal-generating sources 130c. The user of the portable electronic device 110 may have entered offerings of interest into the portable electronic device 110 that include televisions and laptop computers, but not headphones.

The portable electronic device 110 may include a directional apparatus 220. The directional apparatus 220 may be built into the portable electronic device 110. In other embodiments, the directional apparatus 220 is separate from, but in communication with, the portable electronic device 110.

The antenna module 202 may receive the wireless signals 130a-c, and the offering module 204 may determine the offering identifiers that are part of the respective wireless signals 130a-c. The filter module 206 may also match the offering identifiers with the offerings of interest selected by the user. In the example of FIG. 5, the filter module 206 may determine that the offering identifiers found in the wireless signals 115a and 115b match the offerings of interest selected by the user.

The direction module 208 may determine a direction from which the wireless signals 115a-c are received based on the strength of the wireless signal 130a-c received by the antenna 302. In certain embodiments, the direction module 208 performs this action for each wireless signal 115a-c received by the antenna module 202. In other embodiments, the direction module 208 performs this action only for those wireless signals 115a-c that contain an offering identifier that matches the offerings of interest selected by the user.

The notification module 210 presents indicators 404a-b in response to the offering identifiers matching the offerings of interest selected by the user. For example, as seen in FIG. 5, an indicator 404a indicates the direction to the location of the external signal-generating source 130a. The indicator 404b indicates the direction to the location of the external signal-generating source 130b. In FIG. 5, the indicators 404a-b include text (“TV” and “Laptops”) that further identify what is available at the location of the external signal-generating source 130a-b. In FIG. 5, headphones were not an offering of interest selected by the user. As a result, there is no indicator 404 indicating the direction to the external signal generating source 130c.

As seen in FIG. 5, the directional apparatus 220 may differentiate between a plurality of wireless signals 115a-c from a plurality of external signal-generating sources 130a-c. The notification module 210 may simultaneously present a plurality of indicators 404a-b to a user, with each indicator 404a-b being associated with one of the plurality of external signal-generating sources 130a-c. The indicators 404a-b may allow the user to determine which offering is associated with the particular indicator 404a-b. In the example shown in FIG. 5, a description of the offering is provided with the indicators 404a-b to allow the user to determine what the indicator 404a-b leads to.

In the event that a plurality of external signal-generating sources 130a-c are located in the same direction, such that there are multiple indicators 404a-b indicating the same direction, the indicators 404a-b may be presented such that each indicator 404a-b is understood by the user. For example, if the indicators 404a and 404b in FIG. 5 both pointed up, the indicator 404a may be placed in a first position closest to the edge of the screen 402, while the indicator 404b is placed behind it. Such an arrangement would allow the indicators 404a and 404b to both be visible to, and easily read by, the user.

As discussed above, the user may select offerings of interest. The user may enter these offerings of interest through a variety of approaches. In one embodiment, the offering module 204 determines the offering identifiers from all wireless signals 115a-c in range of the portable electronic device 110. The notification module 210 may present a description of the offering available at the location of the external signal-generating sources 130a-c that generated the wireless signals 130a-c. For example, the notification module 210 may display, on the screen 402, a list of the store names, a description of the products, or services, or some combination thereof, as determined from the offering identifiers. The user may then select one or more of these descriptions and thus provide the offerings of interest.

In another embodiment, the filter module 206 accesses a list of offerings that are available at a location. A “list” is used broadly here to encompass a variety of data structures, including tables, lists, and other suitable data structures. For example, at an electronics trade show, the filter module 206 may access a list on a website for the trade show that provides information about the booths at the trade show, and the products and services available at each booth. The user may then select the offerings of interest from the list of options presented to the user.

In another embodiment, a standardized list of offerings is maintained and available to the filter module 206. For example, a website that is not specific to any particular show may maintain a standard list of offerings. The filter module 206 may present the standard list of offerings to the user and allow the user to selected offerings of interest from that list. The offering identifiers broadcast by the external signal generating sources 130 may be consistent with that list; for example, when a vendor is setting up the external signal-generating source 130a, he may be required to select one or more offering identifiers to be broadcast in the wireless signal 115a from the list. This approach may help ensure that variations in how a product, service, or store may be described will not result in relevant offerings being missed.

In another embodiment, the user can enter the offerings of interest for the filter module 206 in a free form field. The filter module 206 may, in response, search for offering identifiers that match the offerings of interest exactly, or which are close to the offerings of interest. For example, the user may enter the words “flat screens” as an offering of interest. The filter module 206 may determine that “flat screen televisions” is an offering that is available at the trade show the user is attending. Based on the similarity between the words “flat screens” and the offering identifier “flat screen televisions,” the filter module 206 may assume that this is a match. In other embodiments, the filter module 206 may ask the user whether she means “flat screen televisions” and thus clarify the offering of interest.

Combinations of the above approaches may be used to receive offerings of interest from the user. Other approaches not described may also be used. By getting offerings of interest from the user, and matching those to offering identifiers in the wireless signals 115, the user can be directed more precisely to relevant offerings at a trade show, a mall, or other event/location.

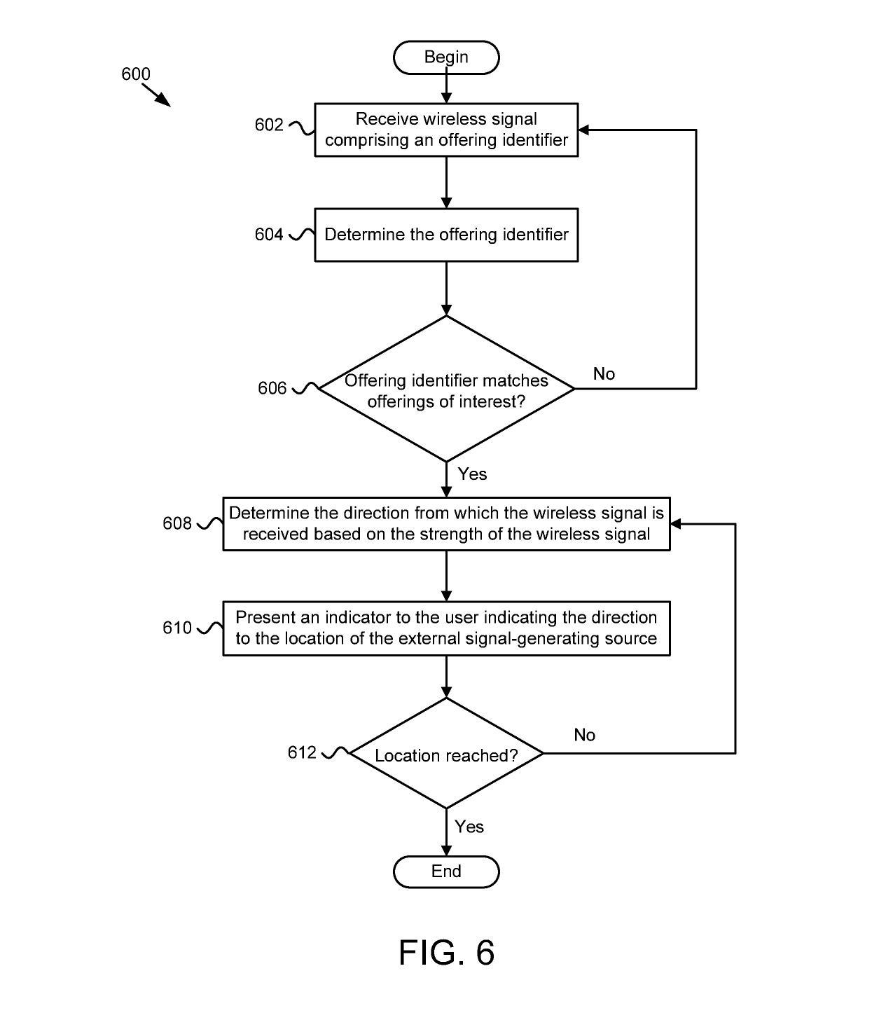

FIG. 6 shows one embodiment of a method 600 for directing a user to relevant offerings based on a wireless signal. In one embodiment, the method 600 begins with receiving 602 a wireless signal 115 comprising an offering identifier. In certain embodiments, the offering identifier is a description of a product or service, a brand name, an alphanumeric identifier that can be associated with a description of a product or service or a brand name, or some combination thereof. The method 600 may also involve determining 604 the offering identifier from the wireless signal 115.

The method 600 may also involve determining 606 whether the offering identifier matches one or more offerings of interest selected by a user. If there are no matching offering identifiers, the method 600 may involve continuing to receive wireless signals 115 as described above.

In response to the identifier matching the offering of interest, the method 600 may further involve determining 608 the direction from which the wireless signal 115 is received based on the strength of the wireless signal 115. As noted above, an antenna module 202 may include a multi-directional antenna 302 that includes two or more segments 304. Determining the direction from which the wireless signal 115 is received may involve determining the strength of the wireless signal 115 at the one or more segments 304 of the antenna 302, and extrapolating from that information about the strength of the wireless signal 115 the direction to the external signal-generating source 130 that generated the wireless signal 115. The direction module 208 may determine the strength of the wireless signal 115 at each of the segments 304 in order to extrapolate the direction.

The method may further involve presenting 610 an indicator 404 to the user indicating the direction to the location of the external signal-generating source 130 that generated the wireless signal 115. In one embodiment, presenting an indicator 404 involves displaying a graphical arrow on a screen 402 of the portable electronic device 110, where the graphical arrow points to the direction of the external signal-generating source 130. Where multiple wireless signals 115 are received, and where multiple offering identifiers match offerings of interest selected by the user, the notification module 210 may present multiple indicators 404, with each indicator 404 being associated with one of the wireless signals 115.

The method may further involve determining 612 whether the user with the portable electronic device 110 has reached the location of the external signal-generating source 130. The direction module 208 may be configured to indicate that the portable electronic device 110 is at the location of the external signal-generating source 130 when the portable electronic device 110 is within a specified distance of the location. For example, the direction module 208 may indicate that the portable electronic device 110 is at the location when the portable electronic device 110 is within five feet of the external signal-generating source. If the location is not reached, the method may involve repeating the steps 608 and 610 until the location is reached. The looping of steps 608-612 may also terminate in response to other events; for example, the user may indicate that the user is no longer interested in the location, turn off the portable electronic device 110, or take other action to terminate the loop.

In certain embodiments, the direction module 208 determines the distance of the portable electronic device 110 to the external signal-generating source 130 based on a response message generated by the portable electronic device 110. For example, the direction module 208 may ping the external signal-generating source 130 and calculate a time necessary for a response message to be received. The direction module 208 may use the response time to determine an approximate distance separating the portable electronic device 110 and the external signal-generating source 130. Other approaches to determining the distance between the portable electronic device 110 and the external signal-generating source 130 may also be used.

In certain embodiments, the method also involves monitoring the orientation of the portable electronic device 110 and dynamically adjusting the position of the indicator 404 to adjust for changes in orientation of the portable electronic device 110. The method may also involve continually monitoring the changes in the position of the portable electronic device 110 based on the strength of the wireless signal 115, and updating the indicators 404 to account for changes in the position of the portable electronic device 110.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a wireless signal from an external signal-generating source, the wireless signal comprising an offering identifier associated with an offering at a location of the external signal-generating source;
determining the offering identifier from the wireless signal;
matching the offering identifier with one or more offerings of interest selected by a user;
determining a direction from which the wireless signal is received based on a strength of the wireless signal received by an antenna; and
presenting an indicator to the user that indicates the direction to the location of the external signal-generating source in response to the offering identifier matching with one or more of the offerings of interest selected by the user.

2. The method of claim 1, wherein the antenna is a multi-directional antenna comprising two or more segments.

3. The method of claim 2, further comprising determining the strength of the wireless signal at one or more of the segments of the multi-directional antenna.

4. The method of claim 3, wherein determining the direction from which the wireless signal is received based on the strength of the wireless signal received by an antenna further comprises determining the strength of the wireless signal at each of the one or more segments of the multi-dimensional antenna.

5. The method of claim 2, wherein the antenna is a multi-directional antenna comprising four segments.

6. The method of claim 1, wherein presenting an indicator to the user further comprises displaying a graphical indicator on a screen of a portable electronic device, the graphical indicator indicating the direction to the location of the external signal-generating source.

7. The method of claim 6, further comprising dynamically adjusting a position of the graphical indicator in response to one or more of:
a change in orientation of the portable electronic device; and
a change in a location of the portable electronic device.

8. The method of claim 1, further comprising differentiating between a plurality of wireless signals from a plurality of external signal-generating sources.

9. The method of claim 8, further comprising simultaneously presenting a plurality of indicators to the user, each indicator being associated with one of the plurality of external signal-generating sources.

10. The method of claim 1 wherein the wireless signal is received by a cellular phone.

11. The method of claim 1, wherein the offering identifier comprises one or more of a digital identification, a store name, product information, and service information.

12. The method of claim 11, wherein at least one of the store name, product information, and service information is received by a portable electronic device from a source separate from the external signal-generating source.

13. The method of claim 1, wherein the wireless signal is a digital wireless signal comprising digital information.

14. A system comprising:
a portable electronic device comprising a processor and memory;
an antenna module that receives a wireless signal from an external signal-generating source, the wireless signal comprising an offering identifier associated with an offering at the location of the external signal-generating source;
an offering module that determines the offering identifier from the wireless signal;
a filter module that matches the offering identifier with one or more offerings of interest selected by a user;
a direction module that determines a direction from which the wireless signal is received based on a strength of the wireless signal received by the antenna module; and
a notification module that presents an indicator to the user that indicates the direction to the location of the external signal-generating source in response to the offering identifier matching with one or more of the offerings of interest selected by the user.

15. The system of claim 14, further comprising the external signal-generating source, the external signal-generating source sending the wireless signal comprising the offering identifier.

16. The system of claim 14, wherein the portable electronic device is one of a cellular phone, a tablet, and a laptop computer.

17. The system of claim 14, wherein the external signal-generating source comprising a medium range wireless transmitter.

18. An apparatus comprising:
an antenna module that receives a wireless signal from an external signal-generating source, the wireless signal comprising an offering identifier associated with an offering at the location of the external signal-generating source;
an offering module that determines the offering identifier from the wireless signal;
a filter module that matches the offering identifier with one or more offerings of interest selected by a user;
a direction module that determines a direction from which the wireless signal is received based on a strength of the wireless signal received by the antenna module; and
a notification module that presents an indicator to the user that indicates the direction to the location of the external signal-generating source in response to the offering identifier matching with one or more of the offerings of interest selected by the user.

19. The apparatus of claim 18, wherein the antenna module further comprises a multi-directional antenna comprising two or more segments.

20. The apparatus of claim 19, wherein the direction module determines the strength of the wireless signal at one or more of the segments of the multi-directional antenna and determines the direction from which the wireless signal is received based on the strength of the wireless signal at each of the one or more segments of the multi-dimensional antenna.
